(19) United States
(12) Patent Application Publication
(10) Pub. No.: US 2006/0287851 A1
(43) Pub. Date: Dec. 21, 2006

(54) Electronic device and method of keypad function guidance for remote controller used therefor

(75) Inventors: Shingo Kida, Kanagawa-Ken (JP); Takeru Tsuzuki, Kanagawa-Ken (JP)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(73) Assignee: Victor Company of Japan, Ltd.

(21) Appl. No.: 11/453,701

(22) Filed: Jun. 15, 2006

(30) Foreign Application Priority Data
Jun. 21, 2005 (JP) 2005-180296
Mar. 7, 2006 (JP) 2006-60744

(51) Int. Cl. G10L 19/00; G10L 21/00

(52) U.S. Cl. 704/201; 341/176

(57) ABSTRACT

An electronic device that performs several types of operations under control by a remote controller equipped with a plurality of function keypads, has a power supply to supply power to the electronic device, a power controller to control the power supply to turn on or off the electronic device, a display unit to display several types of information, and a display controller to control the display unit to display visual information, in response to an operation of a keypad among the function keypads of the remote controller in a keypad function guidance mode in which visual information including guidance on a function of an operated keypad is allowed to be displayed on the display unit. The display controller controls the display unit to display first visual information including guidance on a function of a power keypad among the function keypads of the remote controller when the power keypad is operated in the keypad function guidance mode while no prior visual information including guidance on a function of an operated keypad is being displayed or while second visual information including guidance on a function of an operated keypad other than the power keypad is being displayed. The power controller controls the power supply to turn off the electronic device when the power keypad is operated in the keypad function guidance mode while the first visual information is being displayed.

### CROSS-REFERENCE TO RELATED APPLICATIONS

This application is based on and claims the benefit of priority from the prior Japanese Patent Application No. 2005-180296 filed on Jun. 21, 2005 and No. 2006-060744 filed on Mar. 7, 2006, the entire contents of which are incorporated herein by reference.

### BACKGROUND OF THE INVENTION

The present invention relates to an electronic device that performs several types of operations under control by a remote controller, and a method of keypad function guidance for giving guidance on the functions of several keypads arranged on the remote controller.

Electronic devices, such as image display devices, are usually operated with a remote controller. With advancements in multi-functional electronic devices, the number of keypads has been increased for remote controllers. For example, some types of remote controllers used for image display devices for digital satellite or terrestrial broadcast are equipped with special keypads, customarily not provided to those for conventional analog broadcast, requiring complex and user-unfriendly operations. Users unfamiliar with such remote controllers may have troubles in operation or have to read instruction manuals.

In order to solve such problems, for example, Japanese Un-examined Patent Publication No. 9 (1997)-130695 (document 1) discloses an image display device operated with a remote controller. When a specific button keypad is pressed on the controller, the operation mode is shifted to a guidance (help) mode to give guidance on the functions of several button keypads arranged on the controller. In the guidance mode, a function instruction for a pressed button keypad is displayed on a display panel, with an illustration of the remote controller.

In addition, Japanese Un-examined Patent Publication Nos. 10 (1998)-56676 and 2002-247670 (documents 2 and 3) disclose image display devices with a remote controller, provided with a voice guidance mode for button keypads of the controller.

The document 1 provides display of a function instruction for any button keypad on a display panel when the keypad is pressed. However, since almost uniform function instructions are prepared for all button keypads, users may have troubles in operation or suffer lowered operationality when image display devices (electronic devices) are on the market with such a remote-controller keypad function guidance system.

It is preferable, like disclosed in the documents 2 and 3, to provide a voice guidance mode for button keypads of a remote controller for eyesight handicapped users, in addition to display of keypad function instructions on a display panel. The voice guidance must, however, be easy to understand.

### SUMMARY OF THE INVENTION

In views of the problems discussed above, a purpose of the present invention is to provide an electronic device that performs several types of operations under control by a remote controller with higher operationality, and a method of button-keypad function guidance for giving guidance on the functions of several button keypads arranged on the remote controller, for higher operationality.

The present invention provides an electronic device that performs several types of operations under control by a remote controller equipped with a plurality of function keypads, comprising: a power supply to supply power to the electronic device; a power controller to control the power supply to turn on or off the electronic device; a display unit to display several types of information; and a display controller to control the display unit to display visual information, in response to an operation of a keypad among the function keypads of the remote controller in a keypad function guidance mode in which visual information including guidance on a function of an operated keypad is allowed to be displayed on the display unit, wherein the display controller controls the display unit to display first visual information including guidance on a function of a power keypad among the function keypads of the remote controller when the power keypad is operated in the keypad function guidance mode while no prior visual information including guidance on a function of an operated keypad is being displayed or while second visual information including guidance on a function of an operated keypad other than the power keypad is being displayed, and the power controller controls the power supply to turn off the electronic device when the power keypad is operated in the keypad function guidance mode while the first visual information is being displayed.

Moreover, the present invention provides a method of keypad function guidance for giving guidance on functions of several keypads arranged on a remote controller used for controlling an electronic device having a display unit, comprising the steps of: displaying visual information on the display unit, in response to an operation of a keypad among the function keypads of the remote controller in a keypad function guidance mode in which visual information including guidance on a function of an operated keypad is allowed to be displayed on the display unit; and turning off the electronic device when a power keypad among the function keypads of the remote controller is operated while first visual information including guidance on a function of the power keypad is being displayed.

Furthermore, the present invention provides an electronic device that performs several types of operations under control by a remote controller equipped with a plurality of function keypads, comprising: at least one speaker to output several types of audio information; and a guidance voice controller, responsive to an operation of a keypad among the function keypads of the remote controller in a keypad function guidance mode for giving guidance on a function of an operated keypad, to output first audio information including guidance on the function of the operated keypad, through the speaker; a volume adjuster to adjust the volume of second audio information, other than the first audio information, output through the speaker; and a memory to store a first volume level of the second audio information adjusted by the volume adjuster, a first predetermined reference level and a second predetermined reference level lower than the first predetermined reference level; and a volume controller to control the volume adjuster to lower the volume of the second audio information from the first volume level stored in the memory to a second volume level equal to the second predetermined reference level when the stored first volume level is equal to or higher than the first predetermined reference level in the keypad function guidance mode.

Still furthermore, the present invention provides a method of keypad function guidance for giving guidance on functions of several keypads arranged on a remote controller used for controlling an electronic device, comprising the steps of: generating first audio information in response to an operation of a keypad among the function keypads of the remote controller in a keypad function guidance mode for giving guidance on a function of an operated keypad, the first audio information including guidance on the function of the operated keypad; and lowering the volume of second audio information other than the first audio information from a first volume level that is equal to or higher than a first predetermined reference level to a second volume level equal to a second predetermined reference level lower than the first predetermined reference level when the volume of the second audio information is at the first volume level in the keypad function guidance mode.

Moreover, the present invention provides an electronic device that performs several types of operations under control by a remote controller equipped with a plurality of function keypads, comprising: at least one speaker to output several types of audio information; and a guidance voice controller, responsive to an operation of a keypad among the function keypads of the remote controller in a keypad function guidance mode for giving guidance on a function of an operated keypad, to output first audio information including guidance on the function of the operated keypad, through the speaker; a first volume adjuster to adjust the volume of the first audio information through the speaker in response to an operation of a volume keypad among the function keypads of the remote controller; a second volume adjuster to adjust the volume of second audio information, other than the first audio information, through the speaker, in response to an operation of the volume keypad, the first and second volume adjusters adjusting the volume independently from each other; a first memory to store a volume level of the first audio information adjusted by the first volume adjuster; a second memory to store a volume level of the second audio information adjusted by the second volume adjuster; and a volume controller to control the first volume adjuster to vary the volume of the first audio information through the speaker in response to an operation of the volume keypad in the keypad function guidance mode.

Furthermore, the present invention provides a method of keypad function guidance for giving guidance on functions of several keypads arranged on a remote controller used for controlling an electronic device, comprising the steps of: in response to an operation of a keypad among the function keypads of the remote controller in a keypad function guidance mode for giving guidance on a function of an operated keypad, generating first audio information including guidance on the function of the operated keypad; varying the volume of the first audio information in response to an operation of a volume keypad among the function keypads of the remote controller in the keypad function guidance mode, independently of the volume of second audio information generated other than the first audio information.

### BRIEF DESCRIPTION OF DRAWINGS

FIG. 1 is a block diagram of a first preferred embodiment of an image display device according to the present invention;

FIG. 2 is a plan view illustrating exemplary arrangements of button keypads on a remote controller used in the present invention;

FIG. 3 is a flowchart of a procedure in a method of button-keypad function guidance performed on the image display device in FIG. 1, according to the first embodiment;

FIG. 4 is an illustration of exemplary on-screen and voice guidance according to the present invention;

FIG. 5 is another illustration of exemplary on-screen and voice guidance according to the present invention;

FIG. 6 is still another illustration of exemplary on-screen and voice guidance according to the present invention;

FIG. 7 is a table listing several types of voice guidance messages, each being given when the corresponding button is pressed on the remote controller shown in FIG. 2;

FIG. 8 is a block diagram of a second preferred embodiment of an image display device according to the present invention;

FIG. 9 is a flowchart of a procedure in a method of button-keypad function guidance performed on the image display device in FIG. 8, according to the second embodiment;

FIG. 10 is a block diagram of a third preferred embodiment of an image display device according to the present invention;

FIG. 11 is a flowchart of a procedure in a method of button-keypad function guidance performed on the image display device in FIG. 10, according to the third embodiment;

FIG. 12 is an illustration of exemplary on-screen and voice guidance according to the third embodiment; and

FIG. 13 is another illustration of exemplary on-screen guidance with no voice guidance according to the third embodiment.

### DETAILED DESCRIPTION OF PREFERRED EMBODIMENTS

### First Embodiment

The first embodiment offers higher operationality to an electronic device to perform several types of operations under control by a remote controller, with special functional arrangements to the remote controller.

According to the functional arrangements, the electronic device operates in a specific operation mode when a power button is pressed on the remote controller, in a guidance mode to give guidance on the functions of several button keypads arranged on the controller. The specific operation mode through the power button is different from other operation modes in which the electronic device enters when any other button is pressed in the guidance mode.

The first embodiment as well as second and third embodiments which will be disclosed later employ an image display device, such as a TV, as an example of electronic device. The present invention is, however, applicable to, not only the image display device, but also any other electronic devices.

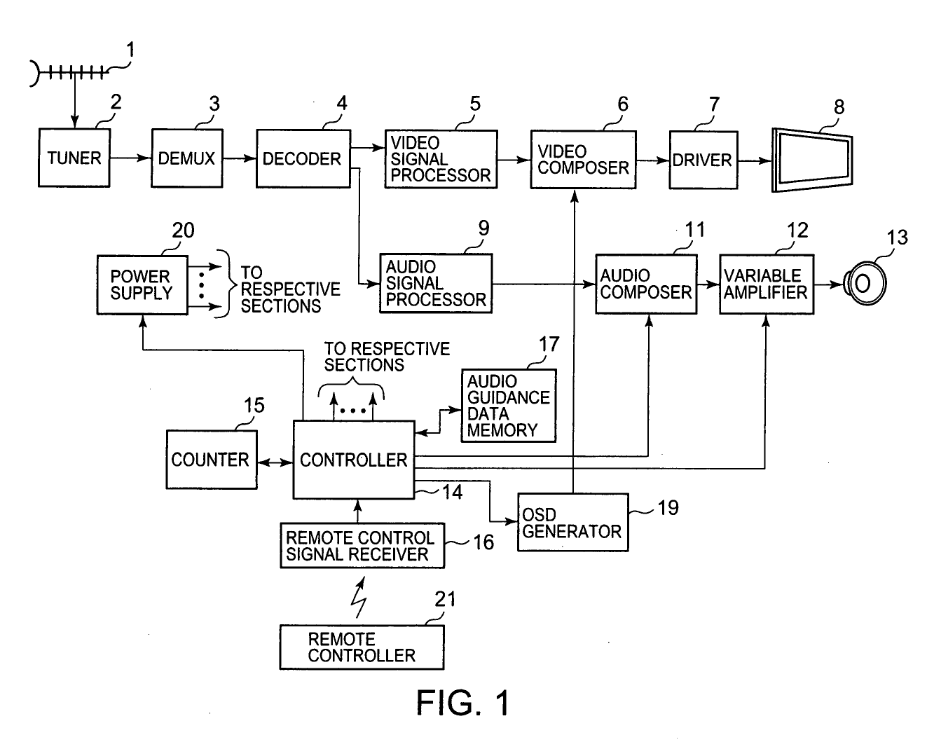

Shown in FIG. 1 is an electronic device, the first embodiment of the present invention.

A digital broadcast wave is received via an antenna 1. The broadcast wave may be a satellite or terrestrial wave. The received broadcast signal is supplied to a tuner 2. The tuner 2 extracts a desired frequency (i.e., channel) signal from the digitally-modulated broadcast signal and outputs a digital stream signal, under control by a controller 14. The stream signal is supplied to a demultiplexer (DEMUX) 3.

The demultiplexer 3 separates the input stream signal into video data, audio data and auxiliary data different from the video and audio data. These data have been compressed with a compression technique, such as, MPEG. The auxiliary data is, for example, TV program data for electronic program guidance. The process of the TV program data is not directly related to the present invention, thus drawing and explanation thereof being omitted. The video and audio data output from the demultiplexer 3 are supplied to a decoder 4, thus being decoded into a video signal and an audio signal, respectively.

The video and audio signals output from the decoder 4 are supplied to a video signal processor 5 and an audio signal processor 9, respectively. The video signal processor 5 processes the video signal for shade, tone, edge enhancement, etc. The audio signal processor 9 processes the audio signal for frequency band enhancement, reverberant sound application, etc. The video signal output from the video signal processor 5 is supplied to a video composer 6 while the audio signal output from the audio signal processor 9 to an audio composer 11.

The video composer 6 combines the video signal and an on-screen signal generated by an OSD (On-Screen Display) generator 19 which will be disclosed later, to supply an on-screen-signal-superposed video signal to a driver 7. It supplies the video signal to the driver 7 with no superposition when the OSD generator 19 generates no on-screen signals.

The driver 7 drives a display unit 8 to display images carried by a video signal on a display screen of the display unit 8. Accordingly, images on a TV program on a particular channel extracted by the tuner 2 is displayed on the display screen of the display unit 8, with or without the on-screen signal being superposed. The display unit 8 may be a liquid crystal panel, a plasma display panel, a cathode-ray tube, a projection display, etc.

The audio composer 11 combines the audio signal and an audio guidance signal generated based on audio guidance data stored in an audio guidance data memory 17 which will be disclosed later, to supply the audio signal superposed with the audio guidance signal to a variable amplifier 12. It supplies the audio signal to the variable amplifier 12 with no superposition when no audio guidance signal is input.

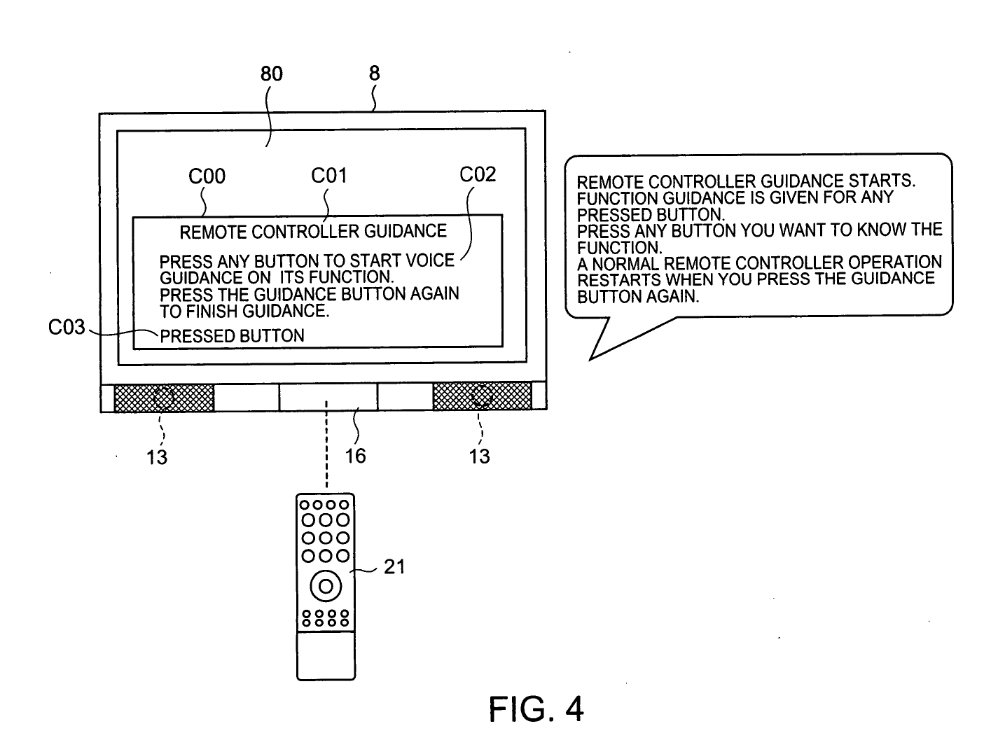

The variable amplifier 12 amplifies the audio signal to gain a desired volume under control by the controller 14 and supplies the amplified audio signal to a speaker 13. Accordingly, a voice on a TV program on a particular channel extracted by the tuner 2 is output through the speaker 13, with or without a guidance voice being superposed. One speaker 13 is shown, however, it is naturally preferable to arrange two or more of speakers to produce stereo sounds. The speaker 13 is installed in the display unit 8, for example, as shown in FIG. 4.

A remote control signal carried by, for example, infrared rays is transmitted from a remote controller 21 to a remote control signal receiver 16. The receiver 16 converts the remote control signal corresponding to a function button on the remote controller 21 to a remote control code in the form of an electrical signal and supplies the code to the controller 14.

The controller 14 controls respective sections in accordance with remote control codes. For example, the controller 14 controls the tuner 2 to switch the TV channel when a channel button is pressed on the remote controller 21. Or, it controls a power supply 20 to turn on or off the image display device when a power button is pressed on the remote controller 21. The controller 14 acts as a power controller for on-off control to the power supply 20.

Moreover, the controller 14 controls the OSD generator 19 to generate an on-screen signal (visual information) when the operation mode is shifted to a guidance mode to give guidance on the functions of button keypads arranged on the remote controller 21, as disclosed later in detail. When shifted to the guidance mode, the controller 14 controls the OSD generator 19 to generate an on-screen signal and also generates a guidance voice signal (audio information) based on the audio guidance data stored in the audio guidance data memory 17. The controller 14 and the OSD generator 19 act as a display controller to display visual information on the display unit 8. The controller 14 and the audio guidance data memory 17 act as a guidance voice controller to output audio information through the speaker 13.

A counter 15 is connected to the controller 14. It measures a button-keypad non-operation period on the remote controller 21 under control by the controller 14.

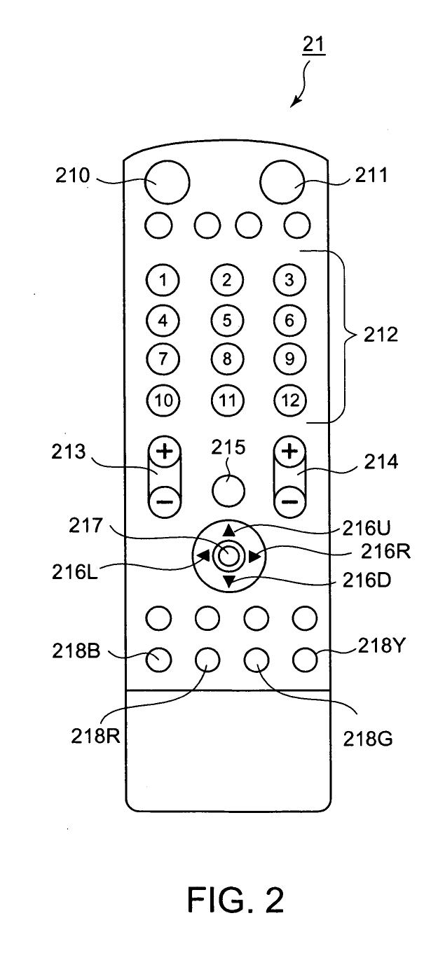

FIG. 2 shows exemplary arrangements of button keypads on the remote controller 21 with illustration of representative keypads.

A guidance button 210 serves to shift the operation mode of the image display device shown in FIG. 1 to the guidance mode. A power button 211 serves to turn on or off the image display device. Numbered buttons 212 serve to directly switch the TV channel and also to enter digits. A channel up/down button 213 serves to select a TV channel by increasing or decreasing the TV-channel number. A volume button 214 serves to increase or decrease volume. A silence button 215 serves to turn off the volume to zero.

Also arranged on the remote controller 21 are cursor buttons 216U, 216D, 216R and 216L, and colored buttons 218B, 218R, 218G and 218Y, which are sometimes referred to as cursor buttons 216 and colored buttons 218, respectively, for convenience, in the following disclosure.

The cursor buttons 216U and 216D serve to move a cursor up and down, respectively. The cursor buttons 216R and 216L serve to move the cursor to right and left, respectively. A set button 217 provided at the center of the cursor buttons 216 serves to set a selected menu item.

The colored buttons 218 are for use in operations on program guidance, data broadcast, etc., for digital broadcast receivers, like the image display device shown in FIG. 1. The buttons 218B, 218R, 218G and 218Y are blue-color, red-color, green-color and yellow-color buttons, respectively.

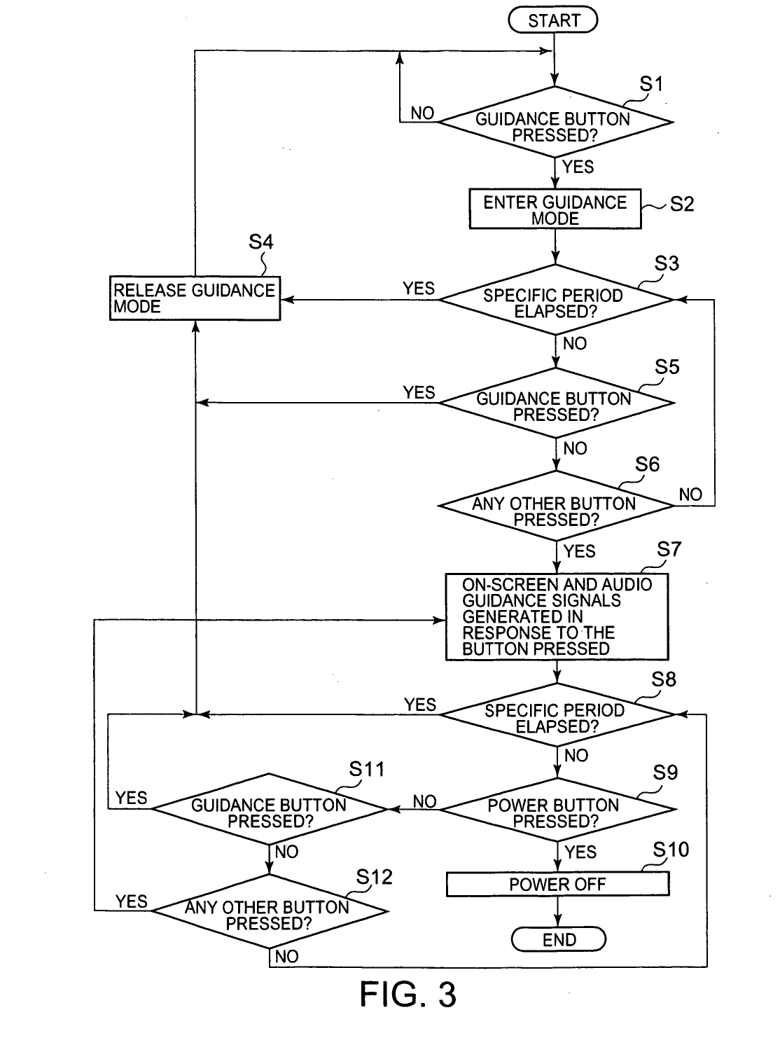

Explained with reference to a flowchart in FIG. 3 and illustrations in FIGS. 4 to 6 is a method of button-keypad function guidance performed on the image display device in FIG. 1, according to the first embodiment.

When the power button 211 is pressed on the remote controller 21 while the image display device is off, the power supply 20 supplies power to the respective sections, under control by the controller 14, thus the image display device being turned on.

The off state of the image display device is so-called a standby mode in which no images are displayed on the display unit 8, with no sounds through the speaker 13, while the controller 14, the remote-control signal receiver 16, etc., are being powered and ready for operation.

The controller 14 starts a procedure shown in FIG. 3 when the image display device is turned on.

In step S1, the controller 14 determines whether the guidance button 210 is pressed on the remote controller 21. The procedure returns to step S1 when the controller 14 determines that the guidance button 210 is not pressed (NO). This state is a normal mode in which a user is viewing a TV program on the display unit 8.

When the controller 14 determines that the guidance button 210 is pressed (YES) in step S1, it allows the image display device to enter a guidance mode, in step S2. The controller 14 functions as a mode switch for the image display device between the normal and guidance modes.

When the operation mode is shifted from the normal to the guidance mode, the controller 14 controls the OSD generator 19 to generate an on-screen signal that carries a frame image C00 and character strings C01 to C03. The character strings C01 to C03 are then displayed on a screen 80 in the display unit 8, as illustrated in FIG. 4.

Displayed on the screen 80 are, such as shown in FIG. 4, the character string C01 “REMOTE CONTROLLER GUIDANCE”, the character string C02 “PRESS ANY BUTTON TO START VOCIE GUIDANCE ON ITS FUNCTION. PRESS THE GUIDANCE BUTTON AGAIN TO FINISH GUIDANCE.”, and the character string C03 “PRESSED BUTTON”, in the frame image C00.

With display of the on-screen guidance messages, the controller 14 reads out audio guidance data from the audio guidance data memory 17, to generate an audio guidance signal and output a voice message through the speaker 13, such as “REMOTE CONTROLLER GUIDANCE STARTS. FUNCTION GUIDANCE IS GIVEN FOR ANY PRESSED BUTTON. PRESS ANY BUTTON YOU WANT TO KNOW THE FUNCTION. A NORMAL REMOTE CONTROLLER OPERATION RESTARTS WHEN YOU PRESS THE GUIDANCE BUTTON AGAIN”.

The audio guidance data memory 17 stores several types of audio guidance data with compressed human guidance voices. The controller 14 selects and decodes a particular type of audio guidance data that corresponds to any pressed button. A signal obtained by decoding the audio guidance data is referred to as an audio guidance signal. The controller 14 supplies a decoded audio guidance signal to the audio composer 11. It is also preferable that the audio guidance data is decoded in the audio guidance data memory 17. Or, the memory may be installed in the controller 14.

The controller 14 has a pre-installed program on a combination of an on-screen signal and an associated audio guidance signal, corresponding to each of several button keypads, in response to the operational transition of the image display device. The operational transition includes shift from the normal mode to the guidance mode, or vice versa, and also from and/or to other several types of modes.

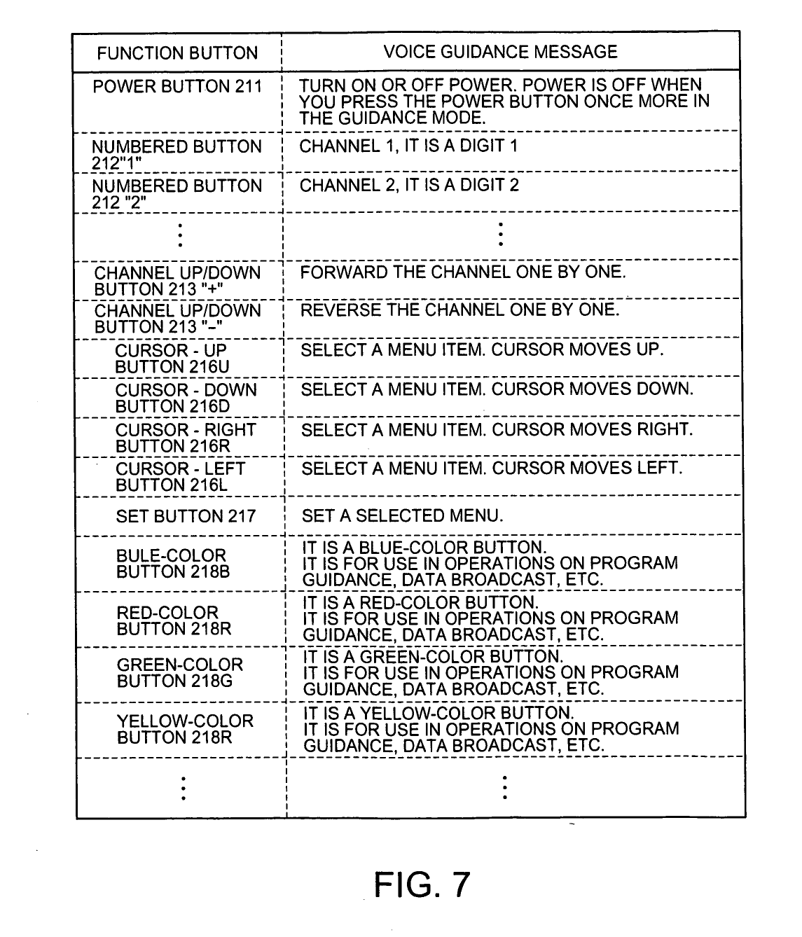

Listed in FIG. 7 are several types of voice guidance messages carried by audio guidance signals, each being generated when the corresponding button is pressed. The audio guidance data memory 17 stores compressed audio guidance data for generating the respective voice guidance messages listed in FIG. 7.

In FIG. 7, a common message for the four cursor buttons 216 is “SELECT A MENU ITEM”, and that for the four colored buttons 218 “IT IS FOR USE IN OPERATION ON PROGRAM GUIDANCE OR DATA BROADCAST”. The audio guidance data memory 17 stores only one compressed audio guidance data for each common message. In other words, this only one data is used for plural numbers of buttons of similar functions. Composing a message with a combination of several pieces of compressed word-by-word audio guidance data is one way of decreasing the amount of data to be stored in the audio guidance data memory 17. Nevertheless, it causes strange pronunciation in voice guidance. To avoid such a problem, the first embodiment employs compressed sentence-by-sentence audio guidance data. Two or more of pieces of such sentence-by-sentence audio data are combined to generate a message composed of two or more of sentences.

Again, in FIG. 3, when the operation mode is shifted to the guidance mode in step S2, the controller 14 starts the counter 15 to measure time from the moment at which the mode is shifted to the guidance mode and then determines whether a specific period of time of, for example, 30 sec., has elapsed, in step S3. The counter 15 is reset whenever any button is pressed on the remote controller 21.

When the controller 14 determines that the specific period of time has elapsed (YES) in step S3, it releases the guidance mode in step S4. Then, the procedure returns to step S1. On releasing the guidance mode, display of the on-screen guidance messages, such as shown in FIG. 4, is cancelled and the operation mode is shifted to the normal mode.

When the controller 14 determines that the specific period of time has not elapsed (NO) in step S3, it determines in step S5 whether the guidance button 210 is pressed.

When the controller 14 determines in step S5 that the guidance button 210 is pressed (YES), it releases the guidance mode in step S4. Then, the procedure returns to step S1.

When the controller 14 determines in step S5 that the guidance button 210 is not pressed (NO), it determines in step S6 whether any other button is pressed.

When the controller 14 determines in step S6 that no other button is pressed (NO), the procedure returns to step S3. Steps S3 to S6 are repeated when it is determined in step S5 that the guidance button 210 is not pressed, and also in step S6, that any other button is not pressed. This repetition of steps determines whether no button is pressed on the remote controller 21 for the specific period time (e.g., 30 sec.) after the operation mode is shifted to the guidance mode.

When the controller 14 determines in step S6 that a button is pressed, other than the guidance button 210 (YES), it allows on-screen and audio guidance signals being generated in response to the button pressed, in step S7.

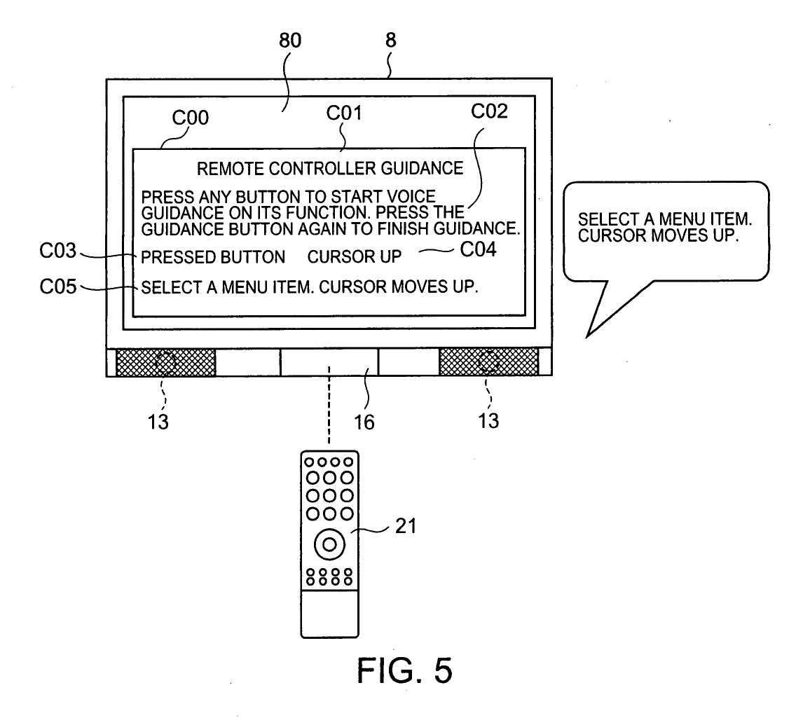

FIG. 5 shows an exemplary illustration of on-screen and voice guidance messages presented when the cursor-up button 216U is pressed.

When the controller 14 determines in step S6 that the cursor-up button 216U is pressed, it controls the OSD generator 19 so that character strings C04 and C05 are displayed in the frame image C00, in addition to the character strings C01 to C03 explained with reference to FIG. 4. In detail, displayed next to the character string C03 is the character string C04 “CURSOR UP”, the name of the pressed button, and under the string C04, the character string C05 “SELECT A MENU ITEM. CURSOR MOVES UP.”, the functional description to explain the function of the cursor-up button 216U.

With the on-screen signal for displaying the on-screen guidance message, the controller 14 generates an audio guidance signal carrying the message “SELECT A MENU ITEM. CURSOR MOVES UP.”, based on the audio guidance data stored in the audio guidance data memory 17.

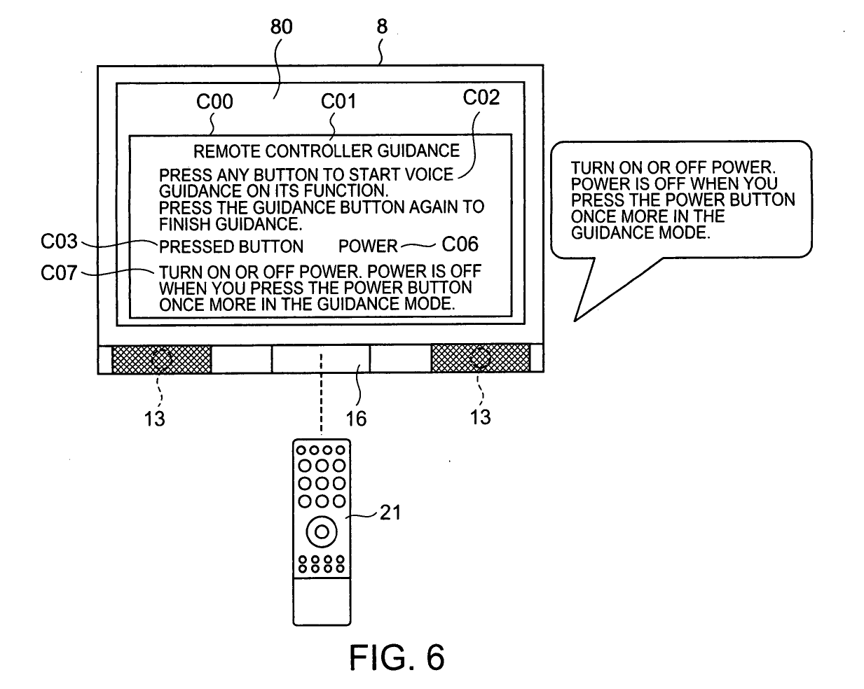

FIG. 6 shows an exemplary illustration of on-screen and voice guidance messages presented when the power button 211 is pressed.

When the controller 14 determines in step S6 that the power button 211 is pressed, it controls the OSD generator 19 so that character strings C06 and C07 are displayed in the frame image C00, in addition to the character strings C01 to C03. In detail, displayed next to the character string C03 is the character string C06 “POWER”, the name of the pressed button, and under the string C06, the character string C07 “TURN ON OR OFF POWER. POWER IS OFF WHEN YOU PRESS THE POWER BUTTON ONCE MORE IN THE GUIDANCE MODE.”, the functional description of the power button 211.

With the on-screen signal for displaying the on-screen guidance message, the controller 14 generates an audio guidance signal carrying the message “TURN ON OR OFF POWER. POWER IS OFF WHEN YOU PRESS THE POWER BUTTON ONCE MORE IN THE GUIDANCE MODE.”, based on the audio guidance data stored in the audio guidance data memory 17.

Although the functional description with character strings and the voice guidance are the completely same as each other in FIGS. 5 and 6, the former may be shortened whereas the latter be more detailed.

Again, in FIG. 3, when the controller 14 allows on-screen and audio guidance signals being generated in response to the button pressed in step S7, it determines in step S8 whether a specific period of time of, for example, 30 sec., has elapsed, like in step S3.

When the controller 14 determines that the specific period of time has elapsed (YES) in step S8, it releases the guidance mode in step S4. Then, the procedure returns to step S1.

When the controller 14 determines that the specific period of time has not elapsed (NO) in step S8, it determines in step S9 whether the power button 211 is pressed.

When the controller 14 determines in step S9 that the power button 211 is not pressed (NO), it determines in step S11 whether the guidance button 210 is pressed.

When the controller 14 determines in step S11 that the guidance button 210 is pressed (YES), it releases the guidance mode in step S4. Then, the procedure returns to step S1.

When the controller 14 determines in step S11 that the guidance button 210 is not pressed (No), it determines in step S12 whether any button is pressed, other than the power button 211 and the guidance button 210.

When the controller 14 determines in step S12 that no other button is pressed (NO), the procedure returns to step S8. Steps S8, S9, S11 and S12 are repeated when it is determined in step S9 that the power button 211 is not pressed, in step S11 that the guidance button 210 is not pressed, and further in step S12 that any other button is not pressed. This repetition of steps determines whether no button is pressed for the specific period time (e.g., 30 sec.) after on-screen and audio guidance signals are generated when a corresponding button is pressed.

The procedure returns to step S7 when the controller 14 determines in step S12 that a button is pressed (YES), other than the power button 211 and also the guidance button 210. This repetition of steps allows a user to press any buttons one by one to know their functions through on-screen guidance on the screen 80 and also voice guidance through the speaker 13. An on-screen guidance message is continuously displayed on the screen 80 as long as no other operation is performed whereas voice guidance is given only once. The same voice guidance is given when the same button is pressed again. A guidance voice is interrupted when another button is pressed and new voice guidance is given for this button.

In step S9, when the controller 14 determines that the power button 211 is pressed (YES), it controls the power supply 20 to turn off the image display device.

As disclosed in detail, the procedure returns to step S7 when any button is pressed in step S12 within the specific period of time (step S8), other than the power button 211 and the guidance button 210. This subroutine in the procedure shown in FIG. 3 allows a user to reassure the function of any button he or she presses twice or more, other than the power button 211. It also allow a user to know the function of another button he or she presses for the first time, other than the power button 211.

On the contrary, when the power button 211 is pressed within the specific period of time after step S7 in which the on-screen and voice guidance messages have been presented for this button 211, as shown in FIG. 6, it is determined in step S9 that the power button 211 is pressed twice in the guidance mode. In this case, power is turned off in step S10, as guided in the on-screen and voice guidance in FIG. 6.

Accordingly, one feature of the first embodiment is that the image display device operates uniquely when the power button 211 is pressed on the remote controller 21 in the function guidance mode. This unique operation is completely different from those when other buttons are pressed in the guidance mode.

In detail, when any button, other than the power button 211, is pressed in the guidance mode, the function of this button is explained with the corresponding on-screen and voice guidance messages in either of two states in which: no prior on-screen guidance message has been displayed; and a prior on-screen guidance message has been displayed for any buttons including the power button 211.

In contrast, there are two types of operation modes when the power button 211 is pressed in the guidance mode.

In one operation mode, the function of the power button 211 is explained with the corresponding on-screen and voice guidance messages in either of two states in which: no prior on-screen guidance message has been displayed; and a prior on-screen guidance message has been displayed for any buttons other than the power button 211.

In the other operation mode, the image display device is turned off when a prior on-screen guidance message has been displayed for the power button 211.

The latter operation mode in the first embodiment allows a user to turn off the image display device whenever he or she wants to do so. This unique operation mode enhances operationality of the image display device compared to a typical conventional procedure.

Usually, a conventional procedure takes two steps to turn off an image display device after shifted to a guidance mode: in a first step, a user presses a guidance button again to actively release this mode or waits for a specific period of time to passively release this mode; and in a second step, he or she presses a power button after the device reenters a normal mode. This procedure bothers a user very much when he or she wants to turn off an image display device quickly.

As disclosed above in detail, the first embodiment solves such a problem and enhances operationality of the image display device.

### Second Embodiment

One feature of the second embodiment is user-friendly button-function voice guidance. The second embodiment has a unique feature in voice guidance, in addition to the feature of the first embodiment in which the image display device operates differently when the power button 211 and the other buttons are pressed on the remote controller 21 in the guidance mode.

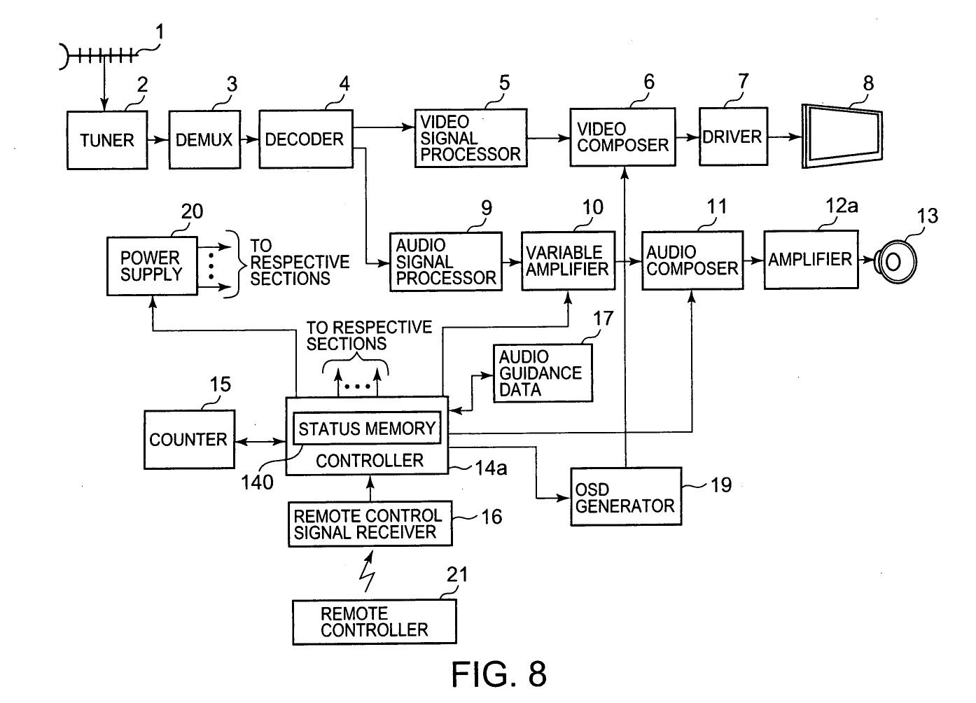

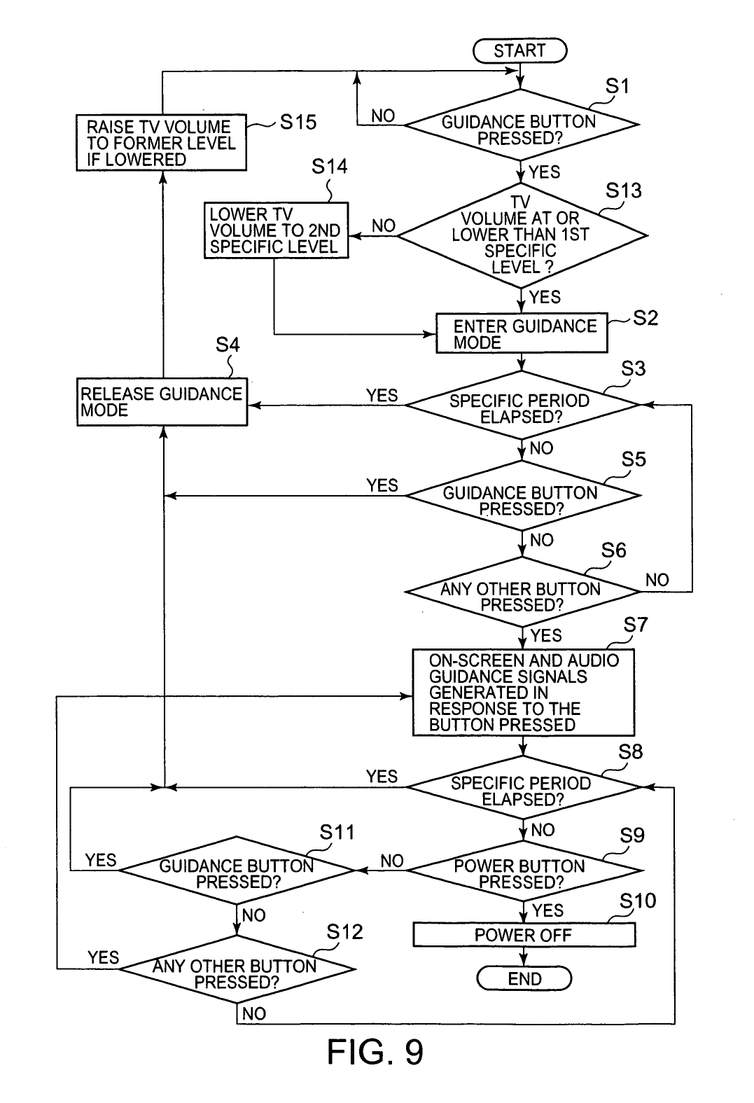

The same reference numerals are given to the sections and steps in FIGS. 8 and 9 that are the same as or analogous to those in function in FIGS. 1 and 3, respectively, with detailed explanation thereof being omitted for brevity.

In an image display device shown in FIG. 8, an audio signal output from an audio signal processor 9, a source of audio signals other than guidance voices, is supplied to an audio composer 11 through a variable amplifier 10. The variable amplifier 10 adjusts the amplitude of the audio signal output from the audio signal processor 9, under control by a controller 14a, in response to a user operation of the volume button 214 or the silence button 215 on the remote controller 21.

The first embodiment in FIG. 1 has the variable amplifier 12 next to the audio composer 11, to adjust the amplitude of an audio signal superposed with an audio guidance signal.

In contrast, the second embodiment in FIG. 8 has the variable amplifier 10 between the audio signal processor 9 and the audio composer 11, to adjust the amplitude of an audio signal output from the processor 9 only. The amplitude of an audio signal output from the audio signal processor 9 corresponds to the volume of a TV program now being tuned and is referred to as a TV volume in the following disclosure. The variable amplifier 10 in the second embodiment functions as a volume adjuster to adjust the volume (TV volume) of voices other than the guidance voices through a speaker 13. Provided between the audio composer 11 and the speaker 13 is an amplifier 12a which may be omitted.

The controller 14a is equipped with a built-in status memory 140 that stores several types of status of the image display device. Exemplary types of the status stored in the memory 140 are: a TV volume level adjusted by the variable amplifier 10; a TV channel received via the tuner 2; a processed state of a video signal at the video signal processor 5; a processed state of an audio signal at the audio signal processor 9; and so on. The status memory 140 is a non-volatile memory that stores the several types of status even after the image display device is turned off. The memory 140 may be separated from the controller 14a.

Explained next with reference to a flowchart in FIG. 9 is a method of button-keypad function guidance performed on the image display device in FIG. 8, according to the second embodiment.

In step S1, the controller 14a determines whether the guidance button 210 is pressed. When the controller 14 determines that the guidance button 210 is pressed (YES) in step S1, it further determines in step S13 whether a TV volume level stored in the status memory 140 is at a predetermined level (first reference level) or lower which is prestored in the memory 140.

The volume of voice guidance (referred to as a guidance volume in the following disclosure) has a predetermined level higher than the first reference level. The voice guidance is given when the operation mode is shifted to the guidance mode in step S2. Or, it is given in step S7.

It is hard to listen to the voice guidance in step S2 or S7 when the TV volume is too loud. To solve such a problem, in the second embodiment, it is determined in step S13 whether a TV volume based on the audio signal adjusted by the variable amplifier 10 is at the predetermined level (first reference level) or lower. If not at the first reference level or lower (NO), the controller 14a controls the variable amplifier 10 in step S14 to lower the TV volume to a second reference level lower than the first reference level. The second reference level is prestored in the status memory 140. The controller 14a in the second embodiment functions as a volume controller to control the variable amplifier 10 (volume adjuster) to adjust the TV volume in the guidance mode.

When the controller 14a releases the guidance mode in step S4, it controls the variable amplifier 10 again in step S15 to raise the TV volume level lowered to the second reference level (step S14) to the former level stored in the status memory 140.

In the procedure shown in FIG. 9, the TV volume is being kept at the second reference level once it is lowered to this level in the guidance mode unless this mode is released.

It is however also preferable to raise the TV volume to the former level at the completion of each voice guidance in step S2 or S7. This is achieved by the following additional steps: determining whether the TV volume is at the first reference level or lower, just before the commencement of each voice guidance; if not, lowering the TV volume to the second reference level; and raising the TV volume to the former level at the completion of each voice guidance.

As disclosed above, the second embodiment has the feature to automatically lower the TV volume if it is too loud when voice guidance is given. In other words, the unique function in the first embodiment in which the image display device is turned off when the power button 211 is pressed twice successively in the guidance mode is not essential for the second embodiment. Nevertheless, the procedure in FIG. 9, that is a combination of the first and second embodiments, is preferable for higher operationality and more comfortable listening to voice guidance with no disturbances with loud TV volume.

### Third Embodiment

One feature of the third embodiment lies in higher operationality of an image display device which operates differently when the volume button 214 and the other buttons are pressed on the remote controller 21 in the guidance mode. Another feature of the third embodiment is user-friendly button-function voice guidance.

Disclosed as the third embodiment is a unique voice guidance function in addition to the features of the first and second embodiments in which the image display device operates differently when the power button 211 and the other buttons are pressed on the remote controller 21 in the guidance mode, and the TV volume is automatically decreased if too loud when voice guidance is given.

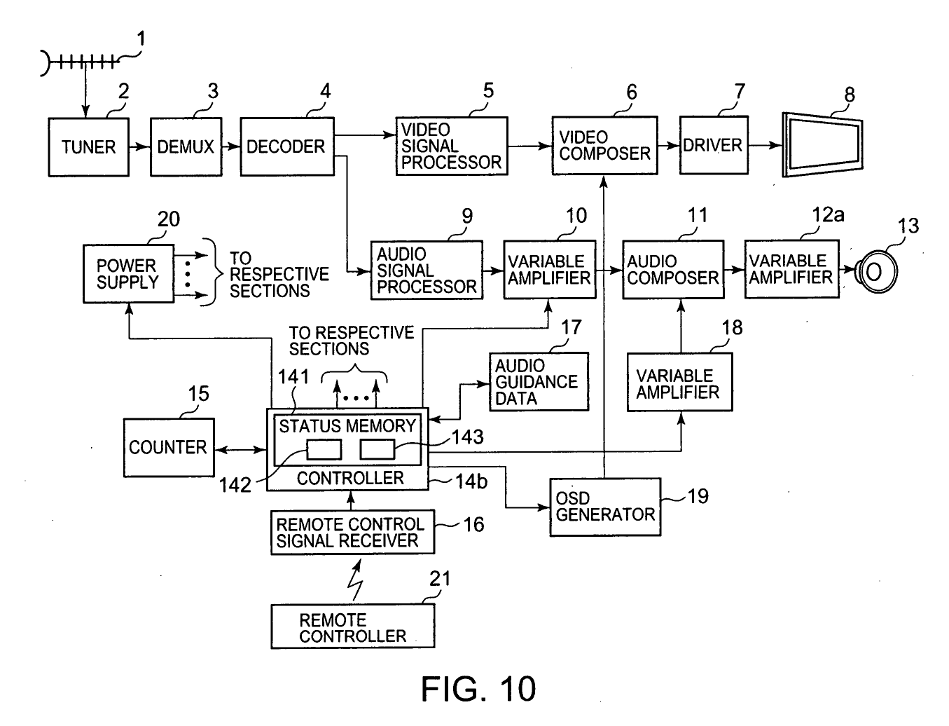

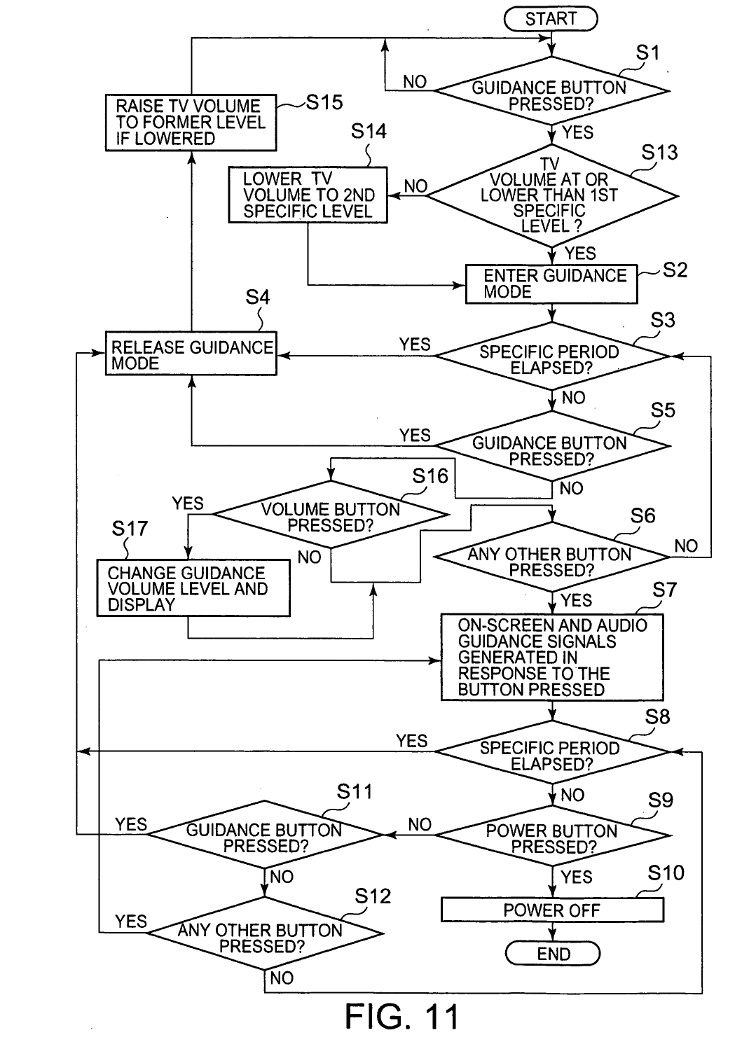

The same reference numerals are given to the sections and steps in FIGS. 10 and 11 that are the same as or analogous to those in function in FIGS. 1 and 8, and 3 and 9, respectively, with detailed explanation thereof being omitted for brevity.

In an image display device shown in FIG. 10, an audio signal output from an audio signal processor 9 is supplied to an audio composer 11 through a variable amplifier 10. The variable amplifier 10 adjusts the amplitude of the audio signal output from the audio signal processor 9, under control by a controller 14b in response to a user operation of the volume button 214 or the silence button 215 on the remote controller 21 for the TV volume in the normal mode.

An audio guidance signal is generated, under control by the controller 14b, when the operation mode is shifted to the guidance mode or when any button is pressed on the remote controller 21 in the guidance mode. The audio guidance signal is then supplied to the audio composer 11 through a variable amplifier 18. The variable amplifier 18 is controlled by the controller 14b to adjust the guidance volume, in response to a user guidance-volume operation with the volume button 214 on the remote controller 21 in the guidance mode. In other words, the variable amplifier 18 is a volume adjuster for the guidance volume through a speaker 13.

The controller 14b is equipped with a built-in status memory 141 that has a TV-volume memory 142 to store a TV volume level adjusted by the variable amplifier 10 and a guidance-volume memory 143 to store a guidance volume level adjusted by the variable amplifier 18. Like the status memory 140 in FIG. 8, the status memory 141 is a non-volatile memory to store data even after the image display device is turned off, which may also be separated from the controller 14b.

With the TV- and guidance-volume memories 142 and 143 to store TV and guidance volume levels, respectively, the third embodiment offers separate adjustments to the TV and guidance volumes.

Moreover, in the third embodiment, the image display device operates differently when the volume button 214 and the other buttons are pressed on the remote controller 21 in the guidance mode, as disclosed later.

Explained next reference to a flowchart in FIG. 11 is a method of button-keypad function guidance performed on the image display device in FIG. 10, according to the third embodiment.

When the operation mode is shifted from the normal to the guidance mode in step S2, the controller 14b controls an OSD generator 19 so that a character string C08, a digit C09 and a graphic C10 are displayed in the frame image C00, in addition to the character strings C01 to C03 explained with reference to FIG. 4.

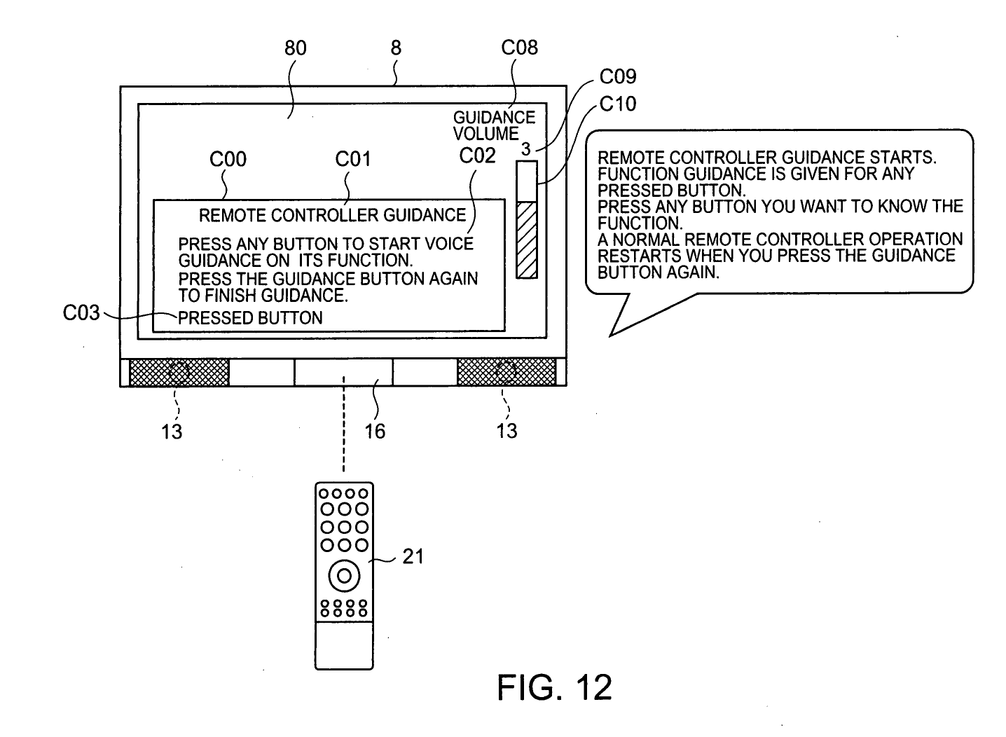

In detail, as shown in FIG. 12, displayed at the right upper corner on the screen 80 is the character string C08 “GUIDANCE VOLUME”, just under the string C08, the digit C09, for example, “3”, the current guidance volume level, and at the right-most section on the screen 80, the graphic C10 that is, for example, a bar graph indicating that the current guidance volume level is 3.

The guidance volume level can be adjusted, for example, within 5 levels, or in the range from 1 to 5. In the initial state when the image display apparatus is shipped, the guidance volume level is adjusted to 3 at the variable amplifier 18 and the level 3 is displayed on the screen 80 through the OSD generator 19, under control by the controller 14b.

Again, in FIG. 11, the controller 14b determines in step S5 whether the guidance button 210 is pressed. When the controller 14b determines in step S5 that the guidance button 210 is not pressed (NO), it determines in step S16 whether the volume button 214 is pressed. If not (NO), the procedure moves onto step S6. The procedure from steps S6 to S12 is the same as that explained with reference to FIG. 3. When the controller 14b determines in step S16 that the volume button 214 is pressed, it controls the variable amplifier 18 to adjust the guidance volume and changes the display of guidance volume level on the screen 80, in step S17.

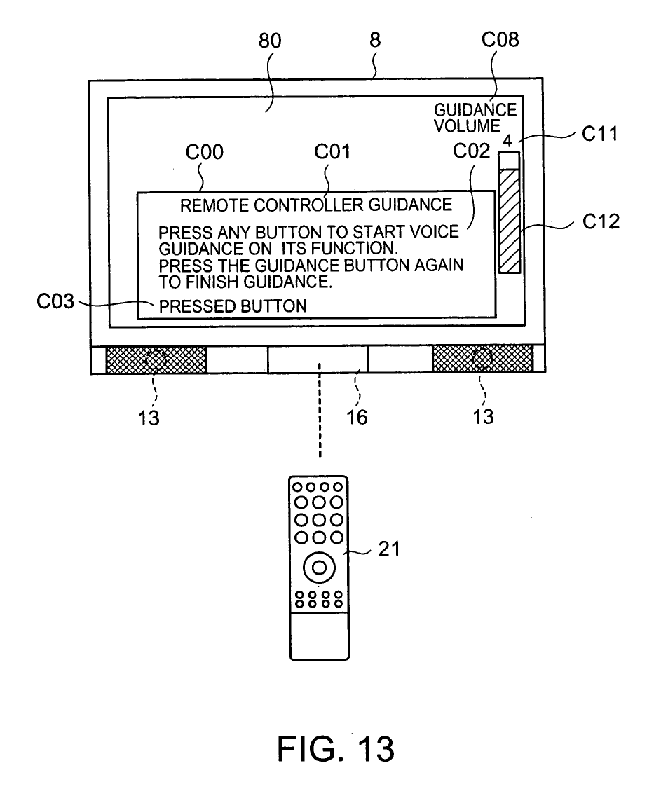

FIG. 13 illustrates an exemplary display on the screen 80 in response to a user operation of the volume button 214 to increase the guidance volume in step S16 in FIG. 11.

As shown in FIG. 13, the digit C09 (FIG. 12) just under the string C08 is changed to a digit C11 indicating the current guidance volume level of 4, with the graphic C10 (FIG. 12) at the right-most section on the screen 80 to a graphic C12, a bar graph indicating that the current guidance volume level is 4.

The adjusted guidance volume level is stored in the guidance-volume memory 143, so that voice guidance is given at the adjusted and stored volume level when the operation mode is returned to the normal mode and again shifted to the guidance mode.

As shown in FIG. 13, the third embodiment does not offer the display of “VOLUME”, the name of the pressed button, next to the character string C03 “PRESSED BUTTON” and also the functional description of the volume button 214, with no voice guidance for such a functional description, when this button is pressed in the guidance mode, different from the first embodiment in FIGS. 5 and 6.

A reason for the third embodiment not to offer such on-screen and voice guidance is that the guidance volume is varied with a user operation of the volume button 214, and then he or she naturally notices the change in guidance volume, i.e., the function of the volume button 214, without such guidance.

Instead of such guidance, the third embodiment allows a user to quickly adjust the guidance volume whenever he or she feels the voice guidance is too loud or inaudible.

As disclosed above, one feature of the third embodiment lies in higher operationality of the image display device which operates differently when the volume button 214 and the other buttons are pressed on the remote controller 21 in the guidance mode. Another feature allows a user to quickly adjust the guidance volume with an operation of the volume button 214, with no on-screen and voice guidance for this button, in the guidance mode.

The following functions unique to the first and second embodiments, respectively, are not essential for the third embodiment: turning off the image display device when the power button 211 is pressed twice successively in the guidance mode; and automatic decrease in TV volume if too loud when voice guidance is given.

Nevertheless, a combination of the third embodiment and the first or the second embodiment is preferable for higher operationality. Moreover, the procedure in FIG. 11, a combination of the third embodiment and the first and second embodiments, is more preferable for higher operationality and more comfortable listening to voice guidance.

The first, second and third embodiments employ the guidance button 210 provided on the remote controller 21 independently from other buttons to allow a user to shift the operation mode between the normal and guidance modes.

Not only such a guidance button, there are several ways to shift the operation mode between the normal and guidance modes within the scope of the present invention.

For example, the operation mode may be shifted between the normal and guidance modes with a combination of operations of two or more of buttons, other than the guidance button 210. Or, it may be shifted to the guidance mode through a menu displayed on the screen 80 of the display unit 8, with an operation of any button, other than the guidance button 210.

As disclosed above in detail, the electronic device and the method of button-keypad function guidance for the remote controller used for the electronic device according to the present invention offer higher device operationality and more user-unfriendly voice guidance.

While the preferred embodiments have been described, it is to be understood that modifications will be apparent to those skilled in the art without departing from the scope of the present invention.

What is claimed is:

1. An electronic device that performs several types of operations under control by a remote controller equipped with a plurality of function keypads, comprising:
a power supply to supply power to the electronic device;
a power controller to control the power supply to turn on or off the electronic device;
a display unit to display several types of information; and
a display controller to control the display unit to display visual information, in response to an operation of a keypad among the function keypads of the remote controller in a keypad function guidance mode in which visual information including guidance on a function of an operated keypad is allowed to be displayed on the display unit,
wherein the display controller controls the display unit to display first visual information including guidance on a function of a power keypad among the function keypads of the remote controller when the power keypad is operated in the keypad function guidance mode while no prior visual information including guidance on a function of an operated keypad is being displayed or while second visual information including guidance on a function of an operated keypad other than the power keypad is being displayed, and
the power controller controls the power supply to turn off the electronic device when the power keypad is operated in the keypad function guidance mode while the first visual information is being displayed.

2. The electronic device according to claim 1 further comprising a mode switch to shift an operation mode of the electronic device between a normal mode and the keypad function guidance mode, in response to an operation of at least one of the function keypads of the remote controller.

3. The electronic device according to claim 1 further comprising:
at least one speaker to output several types of audio information; and
a guidance voice controller, responsive to an operation of a keypad among the function keypads of the remote controller in the keypad function guidance mode, to output first audio information including guidance on a function of an operated keypad, through the speaker.

4. The electronic device according to claim 3 further comprising:
a volume adjuster to adjust the volume of second audio information, other than the first audio information, output through the speaker; and
a volume controller to control the volume adjuster to lower the volume of the second audio information from a first volume level that is equal to or higher than a first predetermined reference level to a second volume level equal to a second predetermined reference level lower than the first predetermined reference level when the volume of the second audio information is at the first volume level in the keypad function guidance mode.

5. The electronic device according to claim 4 wherein the second volume level is maintained during the keypad function guidance mode.

6. The electronic device according to claim 4 wherein the volume controller determines whether the volume of the second audio information is at the first volume level whenever the guidance voice controller attempts to output the first audio information through the speaker.

7. The electronic device according to claim 6 wherein the volume controller controls the volume adjuster to raise the volume of the second audio information to the first volume level from the second volume level whenever the guidance voice controller completes the output of the first audio information through the speaker.

8. The electronic device according to claim 1 wherein the first visual information that is displayed when the power keypad is operated in the keypad function guidance mode includes guidance on an operation mode in which the electronic device is turned off when the power keypad is operated once more while the first visual information is being displayed.

9. A method of keypad function guidance for giving guidance on functions of several keypads arranged on a remote controller used for controlling an electronic device having a display unit, comprising the steps of:
displaying visual information on the display unit, in response to an operation of a keypad among the function keypads of the remote controller in a keypad function guidance mode in which visual information including guidance on a function of an operated keypad is allowed to be displayed on the display unit; and
turning off the electronic device when a power keypad among the function keypads of the remote controller is operated while first visual information including guidance on a function of the power keypad is being displayed.

10. The method according to claim 9 further comprising the step of displaying the first visual information when the power keypad is operated in the keypad function guidance mode while no prior visual information including guidance on a function of an operated keypad is being displayed or while second visual information including guidance on a function of an operated keypad other than the power keypad is being displayed.

11. The method according to claim 9 further comprising the step of generating first audio information in response to an operation of a keypad among the function keypads of the remote controller in the keypad function guidance mode, the first audio information including guidance on a function of an operated keypad.

12. The method according to claim 11 further comprising the step of lowering the volume of second audio information other than the first audio information from a first volume level that is equal to or higher than a first predetermined reference level to a second volume level equal to a second predetermined reference level lower than the first predetermined reference level when the volume of the second audio information is at the first volume level in the keypad function guidance mode.

13. The method according to claim 12 wherein the second volume level is maintained during the keypad function guidance mode.

14. The method according to claim 12 further comprising the step of determining whether the volume of the second audio information is at the first volume level whenever the first audio information is attempted to be generated.

15. The method according to claim 14 further comprising the step of raising the volume of the second audio information to the first volume level from the second volume level whenever the generation of the first audio information is completed.

16. An electronic device that performs several types of operations under control by a remote controller equipped with a plurality of function keypads, comprising:
at least one speaker to output several types of audio information; and
a guidance voice controller, responsive to an operation of a keypad among the function keypads of the remote controller in a keypad function guidance mode for giving guidance on a function of an operated keypad, to output first audio information including guidance on the function of the operated keypad, through the speaker;
a volume adjuster to adjust the volume of second audio information, other than the first audio information, output through the speaker; and
a memory to store a first volume level of the second audio information adjusted by the volume adjuster, a first predetermined reference level and a second predetermined reference level lower than the first predetermined reference level; and
a volume controller to control the volume adjuster to lower the volume of the second audio information from the first volume level stored in the memory to a second volume level equal to the second predetermined reference level when the stored first volume level is equal to or higher than the first predetermined reference level in the keypad function guidance mode.

17. A method of keypad function guidance for giving guidance on functions of several keypads arranged on a remote controller used for controlling an electronic device, comprising the steps of:
generating first audio information in response to an operation of a keypad among the function keypads of the remote controller in a keypad function guidance mode for giving guidance on a function of an operated keypad, the first audio information including guidance on the function of the operated keypad; and
lowering the volume of second audio information other than the first audio information from a first volume level that is equal to or higher than a first predetermined reference level to a second volume level equal to a second predetermined reference level lower than the first predetermined reference level when the volume of the second audio information is at the first volume level in the keypad function guidance mode.

18. The method according to claim 17 wherein the second volume level is maintained during the keypad function guidance mode.

19. The method according to claim 17 further comprising the step of determining whether the volume of the second audio information is at the first volume level whenever the first audio information is attempted to be generated.

20. The method according to claim 17 further comprising the step of raising the volume of the second audio information to the first volume level from the second volume level whenever the generation of the first audio information is completed.

21. An electronic device that performs several types of operations under control by a remote controller equipped with a plurality of function keypads, comprising:
at least one speaker to output several types of audio information; and
a guidance voice controller, responsive to an operation of a keypad among the function keypads of the remote controller in a keypad function guidance mode for giving guidance on a function of an operated keypad, to output first audio information including guidance on the function of the operated keypad, through the speaker;
a first volume adjuster to adjust the volume of the first audio information through the speaker in response to an operation of a volume keypad among the function keypads of the remote controller;
a second volume adjuster to adjust the volume of second audio information, other than the first audio information, through the speaker, in response to an operation of the volume keypad, the first and second volume adjusters adjusting the volume independently from each other;
a first memory to store a volume level of the first audio information adjusted by the first volume adjuster;
a second memory to store a volume level of the second audio information adjusted by the second volume adjuster; and
a volume controller to control the first volume adjuster to vary the volume of the first audio information through the speaker in response to an operation of the volume keypad in the keypad function guidance mode.

22. The electronic device according to claim 21 further comprising:
a display unit to display several types of information; and
a display controller to control the display unit to display visual information on the volume level of the first audio information stored in the first memory in the keypad function guidance mode.

23. The electronic device according to claim 22 wherein the display controller controls the display unit so that no visual information on guidance on a function of the volume keypad is displayed when the volume keypad is operated in the keypad function guidance mode whereas visual information including guidance on a function of a keypad other than the volume keypad is displayed when the keypad other than the volume keypad is operated in the keypad function guidance mode.

24. A method of keypad function guidance for giving guidance on functions of several keypads arranged on a remote controller used for controlling an electronic device, comprising the steps of:
in response to an operation of a keypad among the function keypads of the remote controller in a keypad function guidance mode for giving guidance on a function of an operated keypad, generating first audio information including guidance on the function of the operated keypad;
varying the volume of the first audio information in response to an operation of a volume keypad among the function keypads of the remote controller in the keypad function guidance mode, independently of the volume of second audio information generated other than the first audio information.

25. The method according to claim 24 further comprising the step of displaying visual information on a display unit of the electronic device, the visual information carrying the volume level of the first audio information in the keypad function guidance mode.

26. The method according to claim 25 further comprising the step of controlling the display unit so that no visual information including guidance on a function of the volume keypad is displayed when the volume keypad is operated in the keypad function guidance mode whereas visual information including guidance on a function of a keypad other than the volume keypad is displayed when the keypad other than the volume keypad is operated in the keypad function guidance mode.
